(19) United States
(12) Patent Application Publication
(10) Pub. No.: US 2019/0244518 A1
(43) Pub. Date: Aug. 8, 2019

(54) CONNECTED AUTOMATED VEHICLE HIGHWAY SYSTEMS AND METHODS FOR SHARED MOBILITY

(71) Applicant: CAVH LLC, FITCHBURG, WI (US)

(72) Inventors: Yang Cheng, Middleton, WI (US); Bin Ran, Fitchburg, WI (US); Shen Li, Madison, WI (US); Gang Zhong, Madison, WI (US); Chong Wang, Madison, WI (US); Yuankai Wu, Madison, WI (US); Shuoxuan Dong, Madison, WI (US); Linhui Ye, Madison, WI (US)

(21) Appl. No.: 16/267,800

(22) Filed: Feb. 5, 2019

Related U.S. Application Data
(60) Provisional application No. 62/626,862, filed on Feb. 6, 2018.

(51) Int. Cl. G08G 1/01; G08G 1/0967; G05D 1/00

(52) U.S. Cl. CPC G08G 1/0145; G08G 1/096725; G05D 2201/0213; G05D 1/0088; G08G 1/0125

(57) ABSTRACT

This invention provides a system-oriented solution for mobility sharing service providers to support reliable and safe operations of connected automated vehicles on major urban roads. This system can provide individual vehicles with detailed customized information and time-sensitive control instructions for vehicles to fulfill the driving tasks. The system comprises one or more of: 1) a hierarchical traffic control network of Traffic Control Centers (TCC's), local traffic controller units (TCUs), 2) A RSU (Road Side Unit) network (with integrated functionalities of vehicle sensors, I2V communication to deliver control instructions), 3) OBU (On-Board Unit with sensor and V2I communication units) network embedded in connected and automated vehicles, 4) wireless communication and security system with local and global connectivity, 5) the road network management system managing, 6) a cloud based computing and information platform, and 7) fleet operations and management subsystems.

This application claims priority to U.S. provisional patent application Ser. No. 62/626,862, filed Feb. 6, 2018, which is incorporated herein by reference in its entirety.

### FIELD

The present invention relates generally to a systems and methods that provide vehicle operations and control for a shared mobility service provider (SMSP), or several SMSPs, who operate and manage connected and automated vehicles.

### BACKGROUND

Autonomous vehicles, vehicles that are capable of sensing their environment and navigating without or with reduced human input, are in development. At present, they are in experimental testing and not in widespread commercial use. Existing approaches require expensive and complicated on-board systems, making widespread implementation a substantial challenge.

Alternative systems and methods that address these problems are describe in U.S. patent application Ser. No. 15/628,331, filed Jun. 20, 2017, the disclosure which is herein incorporated by reference in its entirety (referred to herein as a CAVH system). This disclosure provides a transportation management system that provides full vehicle operations and control for connected and automated vehicle and highway systems by sending individual vehicles with detailed and time-sensitive control instructions for one or more or all of vehicle following, lane changing, route guidance, and related information. The system comprises one or more of: 1) a hierarchical traffic control network of Traffic Control Centers (TCC's), local traffic controller units (TCUs), 2) A RSU (Road Side Unit) network (with integrated functionalities of vehicle sensors, I2V communication to deliver control instructions), 3) OBU (On-Board Unit with sensor and V2I communication units) network embedded in connected and automated vehicles, and 4) wireless communication and security system with local and global connectivity. This system provides a safer, more reliable and more cost-effective solution by redistributing vehicle driving tasks to the hierarchical traffic control network and RSU network. Provided herein is shared mobility service provider (SMSP) technology for enhancing such systems.

### SUMMARY

The present invention relates generally to a systems and methods that provide vehicle operations and control for a shared mobility service provider (SMSP), or several SMSPs, who operate and manage connected and automated vehicles.

For example, in some embodiments, provided herein is a transportation management system, and methods of using the same, that provides vehicle operations and control for a shared mobility service provider (SMSP), or several SMSPs, who operate and manage connected and automated vehicles on urban major road networks. In some embodiments, this system provides individual vehicles with detailed customized information and time-sensitive control instructions for vehicle to fulfill the driving tasks such as car following, lane changing, route guidance, and provide operations and maintenance services for vehicles owned and/or operated full time or part time by the aforementioned SMSPs. In some embodiments, the system is built and managed as an open platform; subsystems, as listed below, can be owned and/or operated by different entities, and can be shared among different CAVH systems physically and/or logically.

In some embodiments, the system employs a hierarchy of traffic control centers/units (TCCs/TCUs) that process information and traffic operation instructions. In some embodiments, the TCCs and TCUs are automatic or semi-automated computational modules that focus on data gathering, information processing, network optimization, and/or traffic control.

In some embodiments, the system employs a network of Road Side Units (RSUs) that receive data flow from connected vehicles, detect traffic conditions, and send targeted instructions to vehicles. In some embodiments, the RSU network focuses on data sensing, data processing, control signal delivery, and information distribution. In some embodiments, the point or segment TCU is combined or integrated with an RSU.

In some embodiments, the system employs a vehicle sub-system, that manages a mixed traffic flow of vehicles in different vehicle sharing settings: (1) automated vehicles managed by a SMSP, (2) automated vehicles at different automation level with different ownership; and (3) vehicles with no automation capabilities.

In some embodiments, the system employs one or more communication systems that provide wired and wireless communication services to all the entities in the systems, such as V2X functions.

In some embodiments, the system comprises a road network management system that is divided into different levels and/or divisions under geo-fencing or other technologies. The roads can be separated as the major roads (expressways, major arterials, etc), and minor roads, or roads defined by the SMSP; the roads can be operated as both dedicated lanes and non-dedicated lanes, or any combination of the two.

In some embodiments, the system comprises SMSP fleet operations and management system (FOMS) that provides instructions for vehicles serving user's needs and fleet maintenance activities.

In some embodiments, the system comprises a cloud-based computing and information platform that support information processing and computing.

In some embodiments, the system is configured to control and coordinate vehicles at different automation levels including non-automated vehicles driven by humans.

Vehicles in the system have communication devices onboard, that receive information and instructions from the system. In some embodiments, the vehicle automation levels follow the SAE definition and the system is configured to appropriately manage vehicles of each different level. For vehicles of A0 level, the system gives the driver driving assistant information and shares the data among the system. For vehicles of A1-A3 level, the system gives three types of control strategy (1) full control, (2) coordination control, or (3) mixed control to control the targeting vehicle. For vehicles of A4 and A5 level, the system provides global optimization, big data application, safety and mobility improvements.

In some embodiments, for A0 vehicles, some communication devices are installed or given to the occupant before the vehicle drives into the system-covering roads. The communication devices receive the information from the system. If the occupant follows the instruction from the communication devices, the vehicle still can be managed and benefit from the system. A1-A3 vehicles benefit significantly from the system. The system improves the automation level of those vehicles. In some embodiments, the vehicle receives the instruction from the system and drives appropriately, controlled by the road subsystem, vehicle subsystem, other subsystems, or any combination of systems. Many A4 or A5 vehicles may be “smart” enough to handle driving tasks. However, the system and vehicle automation capabilities can be each other's backup system and work together to improve overall mobility and safety.

In some embodiments, the system comprises a vehicle subsystem that realizes sensing based on one or more or all of the following modules:

A) On vehicle equipment (Vehicle Status, Driving Environment Detection);

B) Sensors installed on the vehicle to (1) detect the driving environment around the vehicle, and (2) detect the vehicle status during driving;

C) Data from other subsystems (RSU, TCC/TCU, cloud, SMSP FOMS), which have sensors and information sharing devices to (1) detect the driving environment around the vehicle, and (2) share the information among the system;

D) Communication technology. Different versions of communication systems, transmission medium and communications protocols can enable the communication system, including but not limited to: Wireless communication technologies, such as, WiFi, DSRC, LTE-V, 5G, Bluetooth. Cable communication technologies, such as Ethernet;

E) Data fusion. The data collected by different sensors is sent to the data fusion module by using any of a variety of communication technologies. At the data fusion module, the information is integrated and the processed information is shared to the users in the system.

In some embodiments, the system comprises a vehicle subsystem that realizes planning and decision functions based on one or more of the following modules:

A) The system makes planning and decisions in a microscopic level: (1) longitudinal control (car following, acceleration and deceleration), (2) lateral control (lane keeping, lane changing).

B) The system makes planning and decisions in a mesoscopic level: (1) special event notification, (2) incident detection.

C) The system makes planning and decisions in a macroscopic level: (1) route planning, (2) guidance.

In some embodiments, the system comprises a vehicle subsystem that employs one or more of the following vehicle control methods:

A) Full control: The TCC/TCU and RSU subsystem sense the driving environment, plan the driving route, make the decision, and control the vehicle.

B) Coordination: The TCC/TCU and RSU subsystem and Vehicle subsystem control the vehicle coordinately.

C) Mixed of the Full control and Coordination.

In some embodiments, the system comprises a vehicle subsystem of vehicles owned by different entities, for example, the system owner SMSP, other SMSPs, and private.

In some embodiments, the system provides control and information services to vehicles: (1) fully owned by the SMSP, (2) partially or part-timely operated by the SMSP, or (3) other third party under agreements. The vehicle ownership may vary spatially and/or temporally.

In some embodiments, the road network managed by this system varies based on factors such as traffic volume and road infrastructure categories. In some embodiments, the SMSP can define different levels, e.g., the major roads and the minor roads, on the road networks according to certain factors, including, but not limited to: A) fixed criteria: the transportation hierarchy of the roads, the design traffic capacity, the design speed, the number of lanes, the land width, etc.; B) statistics criteria: the traffic volume, the average speed, the travel time, the volume of the SMSP vehicles, etc. (the statistics criteria can be counted and calculated in different time periods according to the demand); C) infrastructure criteria: the RSU level (including layout density, coverage area, etc.), the high resolution map level, other related infrastructure levels, etc.; and D) incident criteria: the traffic accident, the social event (such as the sports, festival celebration, etc.), the road closure, etc.

In some embodiments, the SMSP defines the major roads using arbitrary single criterion or arbitrary groups of criteria.

In some embodiments, the definitions of major roads and minor roads are static, or changeable with a fixed or dynamic time periods, or temporarily changed according to different situations. An example of such a definition: if an expressway has high RSU level, qualified high resolution map level and high traffic volume, the SMSP can define the expressway as a major road.

In some embodiments, the system employs requirements for RSUs including, but not limited to: A) functions: RSUs on the major roads should have required level of functions to provide full operations and control for vehicles; B) deployment density and coverage: the layout density and coverage of RSUs on the major roads should cover the entire major roads and some other specific requirements under certain situations; C) locations: the locations of RSUs are dynamically adjusted to fulfill the requirements of the system; and D) types: different types of RSUs are used to make the system work including but not limited to fixed location RSU, temporary RSU, mobile RSU (on trucks, drone, etc.)

The system may further employ other infrastructure rules and requirements.

In some embodiments, the system has vehicle various control and cooperation functionality on different road levels: A) major roads: The SMSP system provides full operations and control for vehicles on the major roads by sending individual vehicles with detailed and time-sensitive control instructions for vehicle following, route guidance and related information; B) minor roads: Vehicles on the minor roads are operated and controlled by the on-board systems or the drivers. The SMSP system provides auxiliary information for the vehicles if necessary, such as incident information, traffic signal information, etc.; and C) key points: the system can take over the controls of vehicles at some key points, including but not limited to: 1) work zone: the road constructions occupy one or several lanes in the areas; 2) accident-prone area: the accident rates are higher than the thresholds in the areas according to the statistical data; 3) complex interchange: the numbers of exits or entrances or directions are higher than the thresholds in the interchanges.

In some embodiments, the system manages both dedicated lanes and non-dedicated lanes, or any combination of the two. The dedicated lane and non-dedicated lane can be defined as follows:

Dedicated lane: Dedicated lane is defined as the lanes for the exclusive use of the vehicles with automation and communication capabilities. Dedicated lane collects lane traffic information through sensing system and shares them to vehicles on the road. In addition, dedicated lane sends control instructions to vehicles through the lane TCC/TCUs. Dedicated lane can be either physical or logical. Physical dedicated lanes are physically separated from non-dedicated lanes and have fixed entrance and exit. Logical dedicated lanes are not physically separated from non-dedicated lanes, but vehicles require permissions from corridor TCCs/TCUs or SMSP TCCs when entering or leaving.

Non-dedicated lane: Non-dedicated lane is defined as the lanes used by mixed traffic of vehicles with and without certain automation and communication capabilities. Non-dedicated lane collects lane traffic information through sensing system and shares them to the vehicles on lane. Non-dedicated lanes do not mandate vehicle to comply the system control instructions, but may require permission to control vehicles under certain circumstances.

In some embodiments, the system senses and/or obtain the weather, vehicle, traffic, and events on road, including: A) Weather forecast data: weather conditions, road conditions under different weather conditions; B) Vehicle attribute data: speed, location, type, automation level, communication level; C) Traffic state: lane traffic flow, lane occupancy, lane average speed; D) road geometric and information: lane structure data, signal, speed limit, variable speed limit; E) Incidents collection: collect reported incidents on the lanes; and F) Accident prediction: possible accidents/conflicts based on vehicle speed, location, and type.

In some embodiments, the system controls the vehicles on dedicated lanes and non-dedicated lanes. The control method is supported by the RSU on the lanes and the CAVH cloud. The control methods include: A) Speed and headway keeping control: keep the minimal headway and maximal speed on the lane to reach the max possible traffic capacity; B) Conflict avoidance detection & control: detects potential accident/conflicts on the lane, and then send warning messages and conflict avoid instructions to vehicles. Under such situations, vehicles must follow the instructions from the lane management system; C) Lane keeping control: guarantee vehicles driving on the lane not disturb vehicles on the adjacent lanes; D) Lane changing control: guarantee vehicles lane changing in proper orders, with the minimum disturbance to the adjacent vehicles; and E) Entering/exiting dedicated lane control: check the vehicle permission when vehicles request entering the dedicated lane; give vehicle driving instructions when vehicles request leaving the dedicated lane.

In some embodiments, the system employs a hierarchy of interfaces that allows the system to interact and cooperate with the city CAVH operations and other share mobility systems. In some embodiments, the system comprises two kinds of interfaces: information sharing interfaces and vehicle control interfaces.

Information sharing interfaces: A) an interface that shares and obtains traffic data such as vehicle density, velocity and trajectory from a city CAVH system and other share mobility systems; B) an interface that shares and obtains incidents such as traffic events, extreme weather and pavement breakdown from a city CAVH system and other share mobility systems; C) an interface that shares and obtains passenger demand patterns from other share mobility systems; D) an interface that dynamically adjusts prices according to the instruction given by a city CAVH system; and e) an interface that allows special agencies such as vehicle administrative office and police to delete, change, and share information.

Vehicle control interfaces: A) an interface that allows a city CAVH system to take control of its vehicles under certain circumstance; B) an interface that allows its vehicles to form platoons with other SMSP's vehicle when they are driving in the same dedicated/non-dedicated lane; C) and an interface that allows special agencies to take control of the vehicle under extreme conditions such as major accident and natural disaster.

In some embodiments, the system comprises a traffic state estimation system based on the above interfaces. In some embodiments, the system comprises a map matching method for states reported by an OBU, spatial transformation method for states reported by an RSU, a traffic state prediction system, and a data fusion system. The weights of the data fusion method are determined by the quality of information provided by RSUs and OBUs. In non-dedicated lane, the shared vehicle ratio is relatively low, the method gives high weights on predictive and estimated information: it guarantees that the system can give a reliable traffic state when traffic information collected from RSUs and OBUs are not available due to transmission and/or vehicle scarcity issues. It should be noted that the same approach can be used to calculate other information such as weather condition and passenger demand.

In some embodiments, the system provides a dynamical price adjustment method. Satisfaction of passengers, profit of SMSPs, and appropriateness of price are important to all SMSPs and their collaboration. The CAVH system collects more reliable information of city mobility through information sharing interfaces of SMSPs and RSUs. Therefore it can give price instructions to SMSPs and helps collaboration between different SMSPs. The SMSP system has a dynamical price adjustment subsystem for dynamic pricing under the instructions. For example, suppose a price per kilometer is pk and price per minute is pm. A travel T with length 1 and travel time Δt is calculated by f(T)=pkl+pmΔt. In some cases, different passengers can share the trip. The system also allows dynamic pricing for ride sharing. During the shared trip T, the price for passenger n is determined by a share parameter sp_n, the price is Sn(T)=sp_n f(T). The system controls parameters pm, pk and sp_n to optimize the satisfactory of passengers and profits of SMSPs. The instructions of CAVH system work as constraints on dynamic pricing. The constraints include maximum/minimum constraints on pk and pm, the maximum/minimum change ratio constraints on pk and pm, the constraints on variance between sp_ns, and weights of passengers' satisfaction and profit of SMSPs.

In some embodiments, the system employs a user priority management module. In some embodiments, the user priority management module defines three levels of priority for vehicles: A) Emergency vehicle: Emergency vehicles have the highest priority on the road; e.g., ambulance, fire truck, police vehicle, school bus, vehicles or fleet for special event (celebration, tournament, etc.); B) Time-sensitive traveler: the system provides with those travelers with the priority to go through bottlenecks and congested areas, such as intersections, ramps, bridges, and tunnels; additional fees may apply; C) Fee-sensitive traveler: those travelers have longer travel times but may be provided with other benefits or incentives such as reduced tolls. In some embodiments, the user priority has a priority tag stored in TCC/TCU. In some embodiments, the RSU produces a queue in sequence of priority. According to this priority queue, the RSU controls vehicles with higher priority to go first or over take ones of lower priority.

In some embodiments, the system employs a SMSP fleet operations and management system (FOMS), whose architectures are different, including but is not limited to:

A) Centralized system architecture. A FOMS control center has all the responsibilities of tasks for a centralized management and operation. Vehicles in the fleet have direct communication with the control center. The fleet can be handled at the corporate level. The advantage of centralization of fleet operation and management is the conciseness of system structure and data flow, which brings down the probability of system errors and improves efficiency and safety in communication.

B) Hierarchical system architecture. In this architecture, there is a hierarchical relationship between each level of FOMS control center. The operation and management tasks are split and personalized for divisions, regions, or subsidiaries, which may be permitted to employ their own fleet administrator or independently supervise their fleet. In contrast to the centralized architecture, the structure and dataflow is relatively complicated and hard to implement in terms of the algorithms and communication methods.

C) De-centralized (self-organized) system architecture. Each vehicle may be permitted to employ their own administrator or supervise, manage, operate themselves independently. While subject to the basic corporate policy of a FOMS control center, the vehicles are on their own in terms of their specific decision making.

In some embodiments, the FOMS operate with the help from of the CAVH architectures and cloud. The foremost assistance CAVH provides is the provision of automation improvement or full drive task take-over from CAVH. The second is the necessary data supplement for FOMS functional services.

The function of FOMS for SMSP mainly focus on the following three aspects:

A) Making scheduling and dispatching strategies for SMSP fleet, that provides on-demand service in the city. To maximize the overall performance of the fleet operation and management, the focus for the FOMS should be optimizing the scheduling and dispatching of vehicles in that fleet on demand. Better strategies lead to shorter possibly time spent and distance traveled in terms of the fleet's vehicles' total consumptions, which results in a lowered fleet operation cost. The involving factors affecting the strategies includes: ridesharing solution, pick-up/drop-off location, etc.

B) Route Guidance for SMSP vehicles. Making optimized decisions regarding best routes for guidance of SMSP fleets uses the CAVH system. The factors affecting the route strategies include the basic information of each vehicle (automation level, occupation level, priority level, etc.). The main principles include maximizing the safety and efficiency of all users within the system, minimizing the possible operating cost, considering CAVH dedicated lanes and non-dedicated lanes, and also considering SMSP's own dedicated operation lanes.

C) Traffic information provision for SMSP fleet. The CAVH system provides specialized traffic information for the SMSP fleet. The information includes events, emergency, weather, road conditions, and traffic data. Solitary SMSP are not able to collect overall traffic information by themselves. The CAVH system, communicating with all SMSP on the road network, have the ability to get access to more comprehensive data sets from all aspects.

The SMSP fleet scheduling and dispatching system manages the deployment of a fleet of demand-responsive SMSP fleet. The system schedules and dispatches vehicles in the fleet based on the demand of customers. With the navigation plan made by the route guidance management system, the system looks for appropriate vehicles around the customer pick-up location and sends the information and management orders to both fleet vehicles and CAVH as well.

In some embodiments, a SMSP fleet route guidance management system makes optimized decisions regarding best routes for guidance of SMSP fleets and uses the CAVH system. The main principles include:

A) The routing decisions are based on the goal of maximizing the safety and efficiency of all users within the system.

B) The routing decisions also minimize the possible operating cost of the SMSP fleets without compromising principle 1.

C) Considering SMSP's own dedicated operation lanes.

The function of this sub-system mainly focuses on the overall route planning and selection considering SMSP service. The system arranges pick-up/drop-off locations and appropriate routes based on customers' demand and the real-time traffic conditions. The system also determines if and when to use CAVH's automation functions based on the fleet vehicle's condition and customers' demand, as well as the priority of this vehicle. The decisions of the guidance management system does not affect the overall operation of CAVH system.

In some embodiments, FOMS employ a SMSP fleet maintenance system comprising:

A) Remote Vehicle Diagnostics system: monitors the health of the vehicle, determines the root cause of the problem/failure, and provides real time information of vehicle parameters to assess its performance against benchmarks. The real-time information communication between an RSU of CAVH system and other vehicles guarantees the accuracy of diagnostic when OBU is partly broken down and/or unavailable.

B) Vehicle maintenance schedules: the schedules considered two solutions. 1) Static maintenance timetable: the schedules are determined by daily usage data recorded by OBU and passengers distribution of SMSPs. The frequency of maintenance is determined by the average usage time and distance calculated from daily usage data. The location of maintenance is determined by passengers' distribution and locations of dedicated lane. 2) Dynamic maintenance instruction: the system monitors vehicle through OBU and RSUs provided by the CAVH system; thus it can real-time detect vehicle risk/breakdown. If some risky factors are detected, the system can dynamically assign the vehicle to maintenance.

C) An intelligent fuel-saving driving system: provides fuel-saving solutions for the whole driving chains. The economic or time-saving behaviors of autonomous vehicle can be determined by passengers.

D) Intelligent charge/refuel system: The system uses fuel consumption and trajectory of vehicle, and predicts the future fuel consumption and trajectory based on historical data saved in cloud system. It plans the charge/refuel behavior to optimize the energy consumption of vehicles. The system gives priorities to the dedicated station of SMSP, and can takes dynamic price of energy into consideration.

Also provided herein are methods employing any of the systems described herein for the management of one or more aspects of traffic control. The methods include those processes undertaken by individual participants in the system (e.g., drivers, public or private local, regional, or national transportation facilitators, government agencies, etc.) as well as collective activities of one or more participants working in coordination or independently from each other.

### DRAWINGS

FIG. 1 shows exemplary information from a vehicle subsystem.

FIG. 2 shows exemplary information from a road subsystem.

FIG. 3 shows exemplary data fusion, planning, and decision processes of the system.

FIG. 4 shows exemplary subsystem and data flow of a road network management system.

FIG. 5 shows an exemplary process of vehicles entering major roads.

FIG. 6 shows an exemplary process of vehicles exiting major roads.

FIG. 7 shows an exemplary framework of a lane management sensing system and its data flow.

FIG. 8 shows an exemplary process of vehicle control of dedicated lane.

FIG. 9 shows an exemplary process of vehicles entering the dedicated lane.

FIG. 10 shows an exemplary process of vehicles leaving the dedicated lane.

FIG. 11 shows exemplary architecture of system interfaces.

FIG. 12 shows a traffic state estimation system.

FIG. 13 shows a dynamic pricing decision model.

FIG. 14 shows an exemplary vehicle prioritization using RSUs.

FIG. 15 shows data flow between FOMS, CAVH elements, and fleet vehicles being controlled and managed.

FIG. 16 shows an example of how a FOMS system works with assistance from CAVH.

FIG. 17 shows an exemplary architecture of SMSP fleet maintenance.

FIG. 18 shows an exemplary Remote Vehicle Diagnostics and dynamic maintenance system.

FIG. 19 shows an exemplary intelligent fuel-saving driving system.

FIG. 20 shows an exemplary intelligent charge/refuel system.

### DETAILED DESCRIPTION

Exemplary embodiments of the technology are described below. It should be understood that these are illustrative embodiments and that the invention is not limited to these particular embodiments.

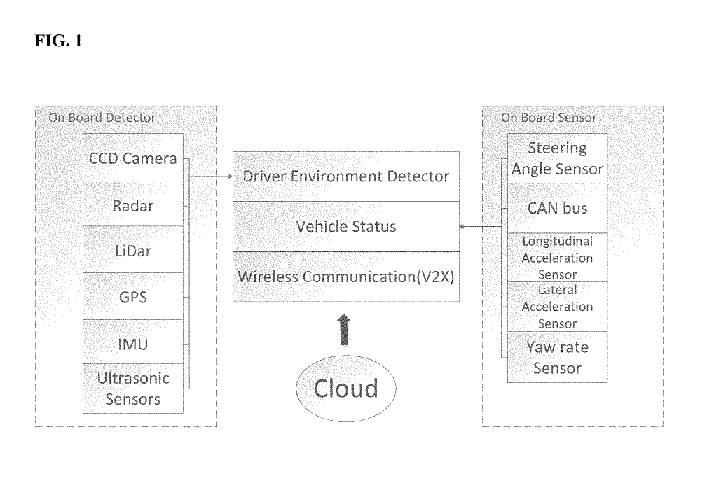

FIG. 1 shows exemplary information from a vehicle subsystem. The vehicle subsystem has three major ways to get the information: 1) an on board detector module senses the driving environment around the vehicle by using multiple detectors; 2) an on board sensor module detects the vehicle status during the driving; and 3) a communication module provides the other information from the entire system by using wired/wireless communication services.

CCD Camera: Fundamentally, a charge coupled device (CCD) is an integrated circuit etched onto a silicon surface forming light sensitive elements called pixels. Photons incident on this surface generate charge that can be read by electronics and turned into a digital copy of the light patterns falling on the device.

Radar: Radar is an object-detection system that uses radio waves. It is widely used in automobile area to detect the range, angle or velocity of objects.

LiDar: Lidar is a surveying method that measures distance to a target by illuminating that target with a pulsed laser light, and measuring the reflected pulses with a sensor.

GPS: GPS is a global navigation satellite system that provides geolocation and time information to a GPS receiver anywhere on or near the Earth where there is an unobstructed line of sight to four or more GPS satellites.

IMU: IMU is an electronic device that measures and reports a body's specific force, angular rate.

Ultrasonic Sensors: Ultrasonic sensor is a device that can measure the distance to an object by using sound waves.

Steering Angle Sensor: The steering angle sensor is a critical part of the ESC system that measures the steering wheel position angle and rate of turn.

CAN Bus: A Controller Area Network (CAN bus) is a robust vehicle bus standard designed to allow microcontrollers and devices to communicate with each other in applications without a host computer.

Longitudinal Acceleration Sensor: Similar to the lateral acceleration sensor in design, but can offer additional information about road pitch and also provide another source of vehicle acceleration and speed.

Lateral Acceleration Sensor: often an accelerometer, and an accelerometer is an electromechanical device used to measure acceleration forces.

Yaw Rate Sensor: Yaw rate sensor is the sensor that measures the rotation rate of the car.

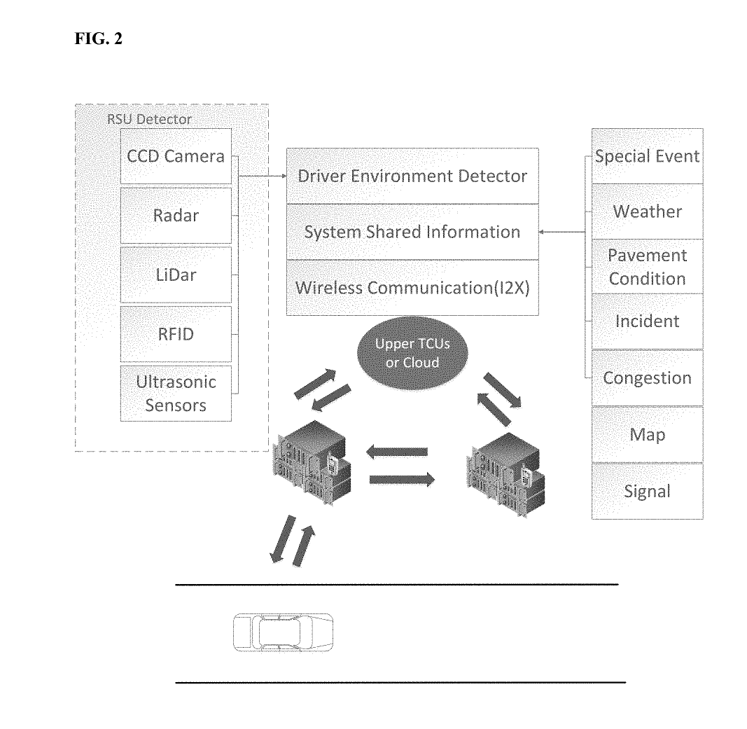

FIG. 2 shows exemplary information from a road subsystem. The road subsystem has three major ways to get the information: 1) an RSU detector module senses the driving environment around the vehicle by using multiple detectors; 2) a system information shared module shares the useful and correct traffic information from other system uses; and 3) a communication module provides other information from the entire system by using wired/wireless communication services.

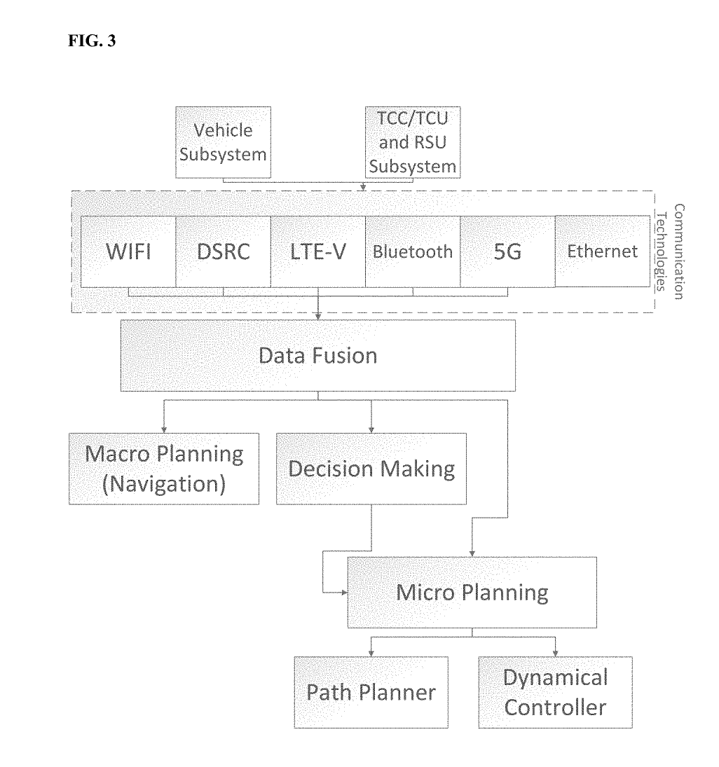

FIG. 3 shows exemplary data fusion, planning, and decision processes of the system. Information flows from a vehicle subsystem and a road subsystem through the communication module to the data fusion module. The communication module may use one or more communication technologies (WiFi, DSRC, LTE-V, Bluetooth, 5G, and Ethernet). After the data output from the Data Fusion module, the system uses the data to do macro planning for the vehicle and make the driving decision. Micro planning is affected by both the Decision Making module and the Data Fusion module. At the end of the planning and decision process, the Path Planner and Dynamical Controller module is the part of the system that controls the vehicle.

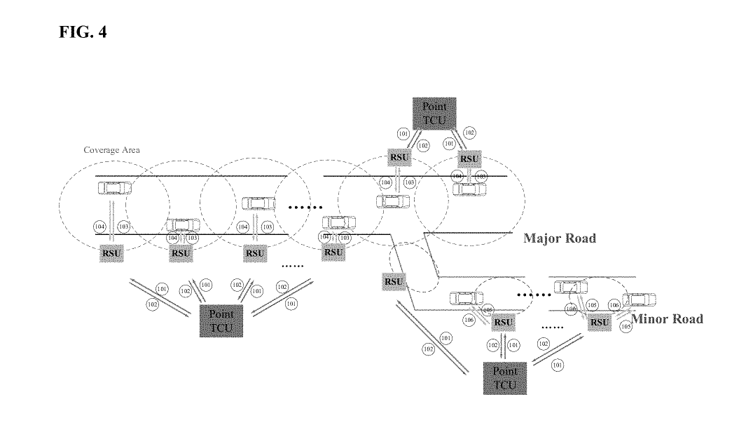

FIG. 4. illustrates an exemplary subsystem and data flow of a road network management system. The point TCU, the RSU, and the vehicles are the main components of the system. On the major road, the RSUs collect the static and dynamic information 104 from the vehicles and send the processed vehicle information 102 to the point TCUs. The point TCUs send the instructions for the vehicles 101 to the RSUs. The detailed vehicle control instructions 103 are sent from the RSUs to the vehicles. The vehicles drive following the control instructions 103. On the minor road, the RSUs collect the necessary information 105 from the vehicles and send the processed vehicle information 102 to the point TCUs. The information for vehicles 101 are sent to the RSUs from the point TCUs. The RSUs send the auxiliary information 105 to the vehicles to assist the vehicles.

### Data Flow:

101—Instructions for Vehicle on the major road/Information for Vehicle on the minor road

### 102—Vehicle Information on the Road

103—Vehicle Control Instructions on the major roads

(1) vehicle control instructions
1. Lateral/Longitudinal position request at certain time
2. Steering and control info
3. Advised speed

(2) Guidance Information
1. Weather
2. Travel time/Reliability
3. Road guidance
   104—Vehicle Static & Dynamic Information on the major roads

(1) Static Information
1. Vehicle ID
2. Vehicle size info
3. Vehicle type info (including vehicle max speed, acceleration and deceleration)
4. Vehicle OBU info

(2) Dynamic Information
[1] Timestamp
[2] Vehicle lateral/longitudinal position
[3] Vehicle speed
[4] Vehicle OD information (including origin information, destination information, route choice information)
[5] Other vehicle necessary state info
   105—Auxiliary information for vehicles on the minor roads
[1] Weather
[2] Travel time/Reliability
[3] Traffic signal info
[4] Incident info
[5] Work zone info
   106—Vehicle Static & Dynamic Information on the minor roads

The information collected from the vehicles on the minor roads are contained in 104. However, not all types of information in 204 are required. RSUs collect the necessary parts of information according to the conditions of the vehicles and the requirements of the system.

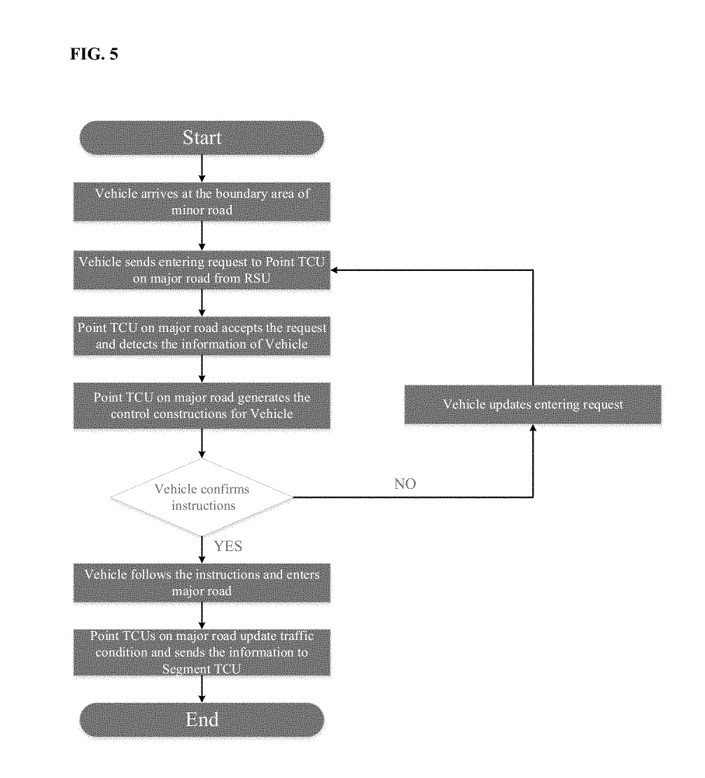

FIG. 5 illustrates an exemplary process of vehicles entering major roads. As shown in the figure, vehicles send the entering requests to RSUs after arriving at the boundary areas of major roads. The boundary area refers to the area around the margin of a major road's control range. RSUs provide the entering requests to Point TCUs on major roads and detect the information of vehicles, including static and dynamic vehicle information, after Point TCUs on major roads accept the entering requests. Point TCUs on major roads formulate the control instructions (such as advised speed, entering time, entering position, etc.) for vehicles to enter the major roads and attempt to take over the control of vehicles, based on the information detected by RSUs. Vehicles receive the control instructions from RSUs and process the instructions with the inner subsystems to decide whether the instructions can be confirmed. Vehicles update and send the entering requests again if the control instructions cannot be confirmed based on the judgment of the inner subsystems. Vehicles drive following the control instructions and enter the major roads if the control instructions are confirmed. Point TCUs on major roads take over the driving control of vehicles, and vehicles keep driving based on the control instructions provided from the system. Point TCUs on major roads update the traffic condition and send the refined information to the Segment TCU after vehicles enter the fully-controlled system.

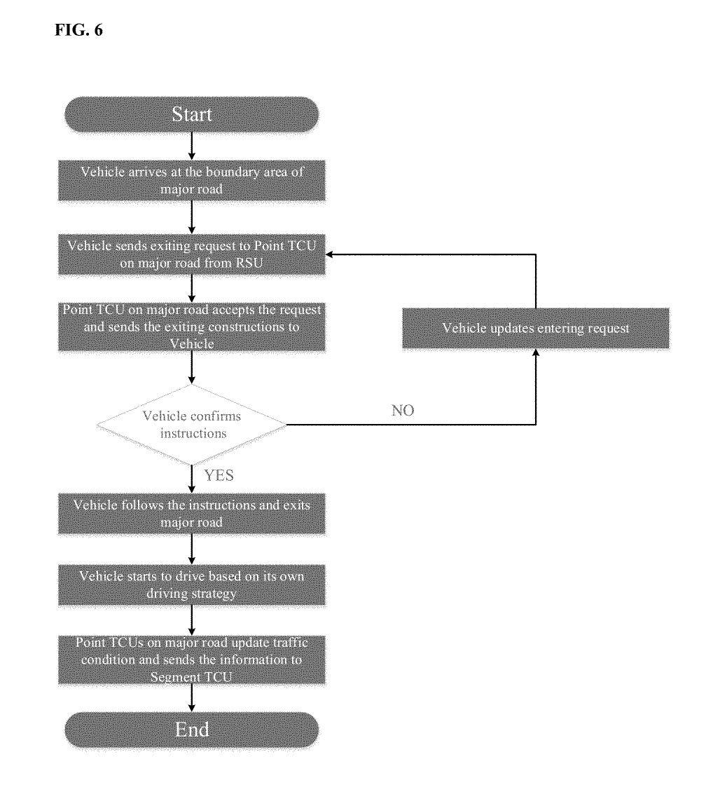

FIG. 6 illustrates an exemplary process of vehicles exiting major roads. As shown in the figure, vehicles send the exiting requests to RSUs after arriving at the boundary area of major roads. The boundary area refers to the area around the margin of a major road's control range. RSUs provide the exiting requests to Point TCUs on major roads. Point TCUs on major roads formulate the exiting instructions (such as advised speed, exiting time, exiting position, etc.) for vehicles to exit the major roads based on the information detected by RSUs. Vehicles receive the exiting instructions from RSUs and process the instructions with the inner subsystems to decide whether the instructions can be confirmed. Vehicles update and send the entering requests again if the exiting instructions cannot be confirmed based on the judgment of the inner subsystems. Vehicles drive following the exiting instructions and exit the major roads if the exiting instructions are confirmed. Point TCUs on major roads terminate the driving control of vehicles, and vehicles start the autonomous driving and follow their own drive strategies after conducting the exiting constructions. Point TCUs on major roads update the traffic condition and send the refined information to the Segment TCU after vehicles exit the major roads.

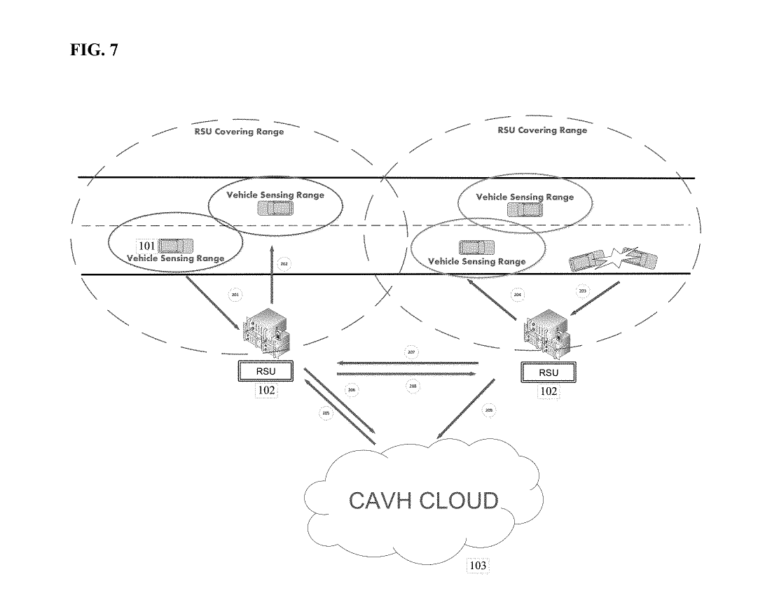

FIG. 7 illustrates an exemplary framework of lane management sensing system and its data flow. In some embodiments, data of the lane management system are exchanged between the vehicles and the road, the information including, but not limited to, weather information, road condition information, lane traffic information, vehicle information, incident information. In some embodiments, the sensing system comprises or consists of:

a) Vehicles 101;

b) RSUs 102; and

c) CAVH Cloud 103.

The data flow of the lane management sensing system is:
a) 201: Vehicles send data collected within their sensing range to RSUs;
b) 202: RSUs collect lane traffic information based on vehicle data on the lane; RSUs share/broadcast their collected traffic information to the vehicles within their range;
c) 203: RSU collects road incidents info from reports of vehicles within its covering range;
d) 204: RSU of the incident segment send incident information to the vehicle within its covering range;
e) 205: RSUs share/broadcast their collected information of the lane within its range to the CAVH cloud;
f) 206: RSUs collect weather information, road information, incident information from the CAVH cloud;
g) 207/208: RSU in different segment share information with each other; and
h) 209: RSUs send incident information to the CAVH cloud.

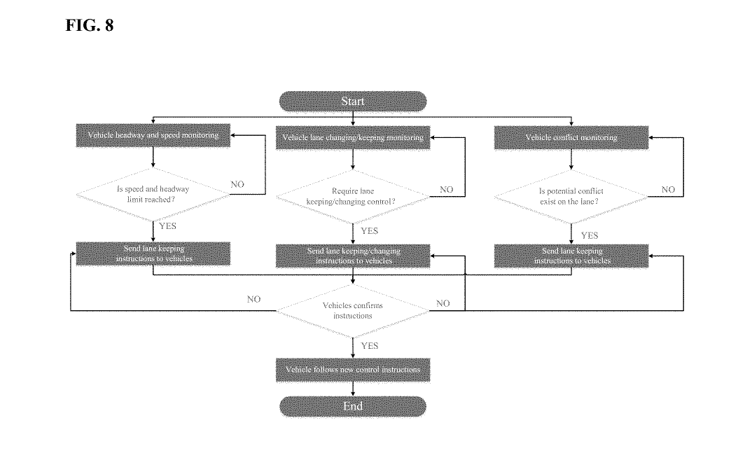

FIG. 8 illustrates an exemplary process of vehicle control of dedicated lane. As shown in the figure, vehicles on the lane are monitored by the RSUs. If related control thresholds (e.g., minimum headway, maximum speed, potential conflict distance, etc.) are reached, the necessary control algorithms are triggered. Then the vehicles follow the new control instructions to drive. If instructions are not confirmed, new instructions are sent to the vehicles.

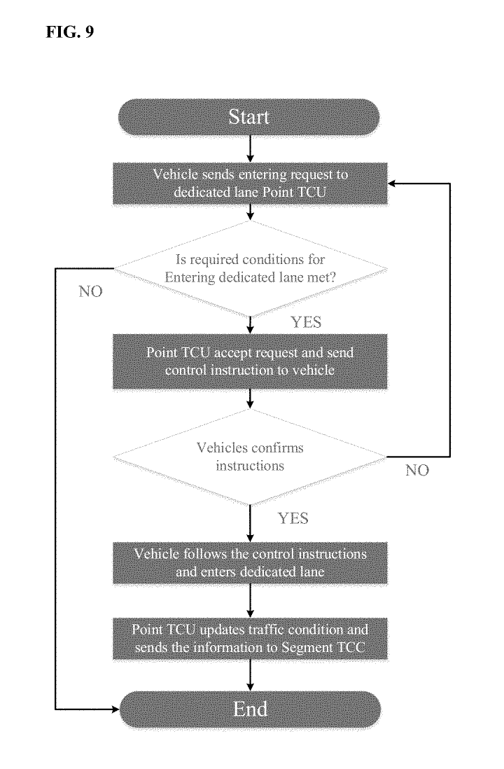

FIG. 9 illustrates an exemplary process of vehicles entering the dedicated lane. As shown in the figure, vehicles send requests to the dedicated lane point TCU (transferred by the RSUs) when intending to enter the dedicated lane. The point TCU checks the required conditions for entering the lane (e.g., the automation and communication level). If all requirements are met, the point TCU sends entering control instructions to the vehicle. The vehicle confirms the control instructions and enters the dedicated lane. Then the point TCU updates traffic condition and sends the information to Segment TCC. If a vehicle failed to meet the required entering conditions, the vehicle is rejected to enter the dedicated lane. If a vehicle failed to confirm the control instructions given by the point TCU, new control instructions are sent to the vehicle.

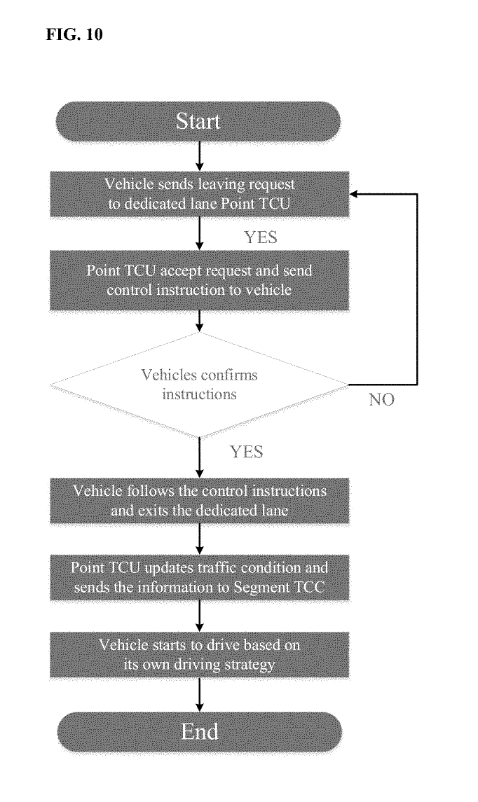

FIG. 10 illustrates an exemplary process of vehicles leaving the dedicated lane. As shown in the figure, vehicles send requests to the dedicated lane point TCU (transferred by the RSUs) when they intend to exit the dedicated lane. The point TCU accepts the requests and sends leaving control instructions to the vehicle. The vehicle confirms the control instructions and leaves the dedicated lane. Then the point TCU updates traffic condition and sends the information to Segment TCC. If a vehicle failed to confirm the control instructions given by the point TCU, new control instructions are sent to the vehicle.

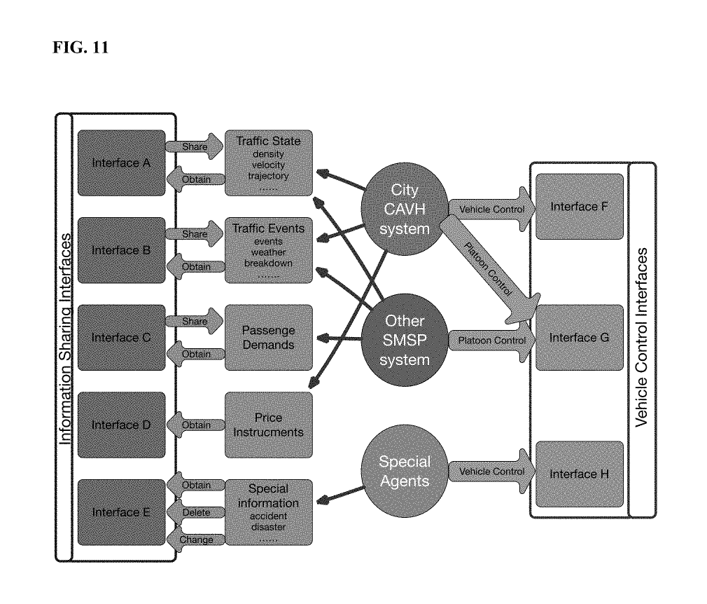

FIG. 11 shows exemplary architecture of system interfaces. In some embodiments, the system contains two kinds of interfaces: a) Information sharing systems: that allow sharing information with city CAVH system, other SMSP systems and special agents; and b) Vehicle Control interfaces: that allow city CAVH system, other SMSP systems and special agents to control the system's vehicles.

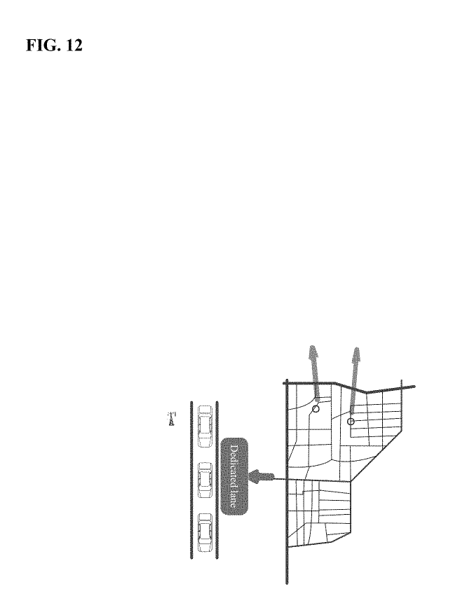

FIG. 12 shows a traffic state estimation system. The traffic state estimation system mainly uses data collected from three sources: 1) data collected from RSUs of CAVH systems, 2) data collected from OBUs of SMSPs, and 3) events reported by CAVH systems, SMSPs and special agents. A weighted traffic state fusion approach is applied to data fusion, the weights are determined by the data quality collected from RSU and OBU.

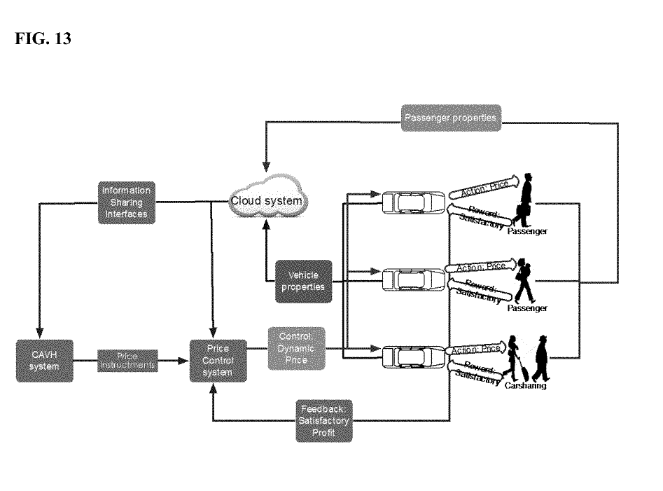

FIG. 13 shows an dynamic pricing model. To achieve dynamic pricing, the system stores passengers' and vehicles' properties in the cloud system. The satisfactory and overall profit is the reward of the control system, and is feedback to control system, the control system then optimizes the price based on the given records.

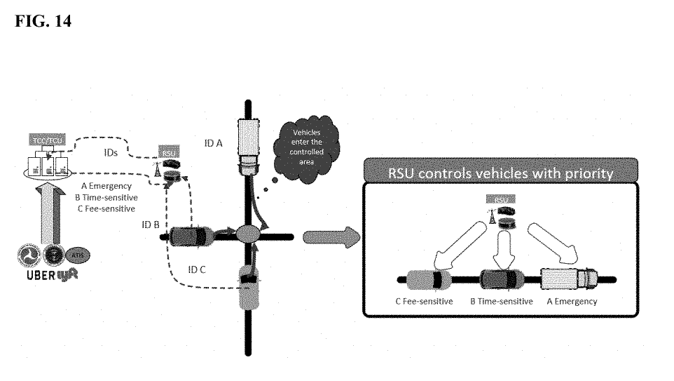

As shown in FIG. 14, when a time slot starts, an RSU collects all the data including VIN sent by the vehicles entering its controlled area, then it retrieves their priorities from TCC/TCU. TCC/TCU has several information resource: DoT, government, ATIS and SMSP. After the priority data are received, the RSU produces three vehicle queues at different priority level: emergency vehicle queue (highest priority), time-sensitive vehicle queue (medium priority) and fee-sensitive vehicle queue (lowest priority). For vehicles in same priority level, they will queue as FIFO (first in, first out). Then the RSU controls the vehicles with higher priorities to overtake others or go through first.

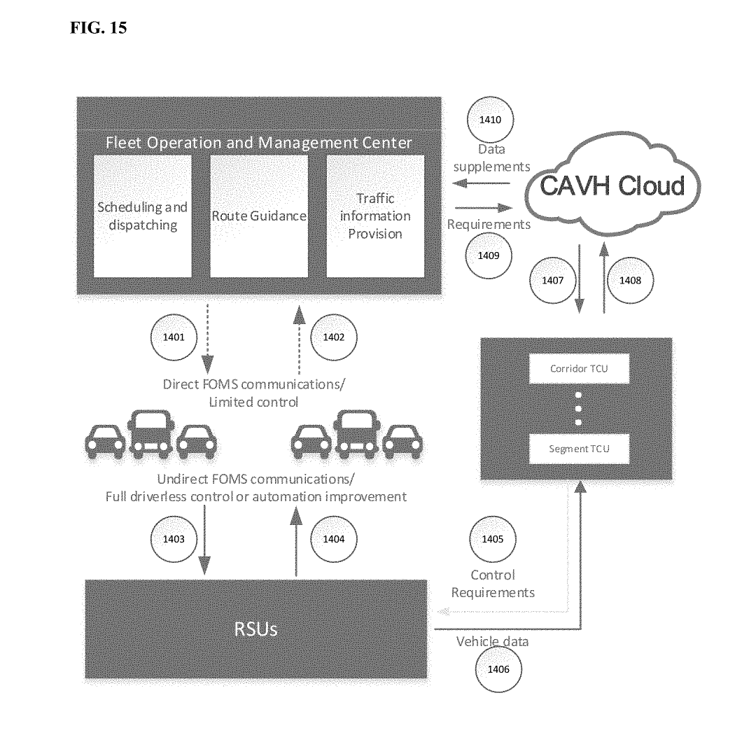

FIG. 15 describes data flow between FOMS, CAVH elements, and the fleet vehicles being controlled and managed. The FOMS realize its fleet's operation and management goals with the data and functional supplement of CAVH. In some embodiments, there are two types of communication between FOMS center and the fleet it owns: direct and indirect communication. The first type is direct communication, which allows FOMS center to send/receive data directly to/from fleet vehicles. The second type is indirect communication through CAVH architectures, with the help of TCU/RSUs. The functions that need help from CAVH system is done in this way. The functions include the provision of automation improvement or full drive tasks taken over from CAVH, as well as the necessary data supplement for FOMS functional services. The control requirement flows through the CAVH architecture and sends to the fleet with the connection of RSU and fleet vehicles. The large number of vehicles' raw data is collected and send back to CAVH cloud. With filters and processors in CAVH system, the processed data can be sent back to FOMS center.

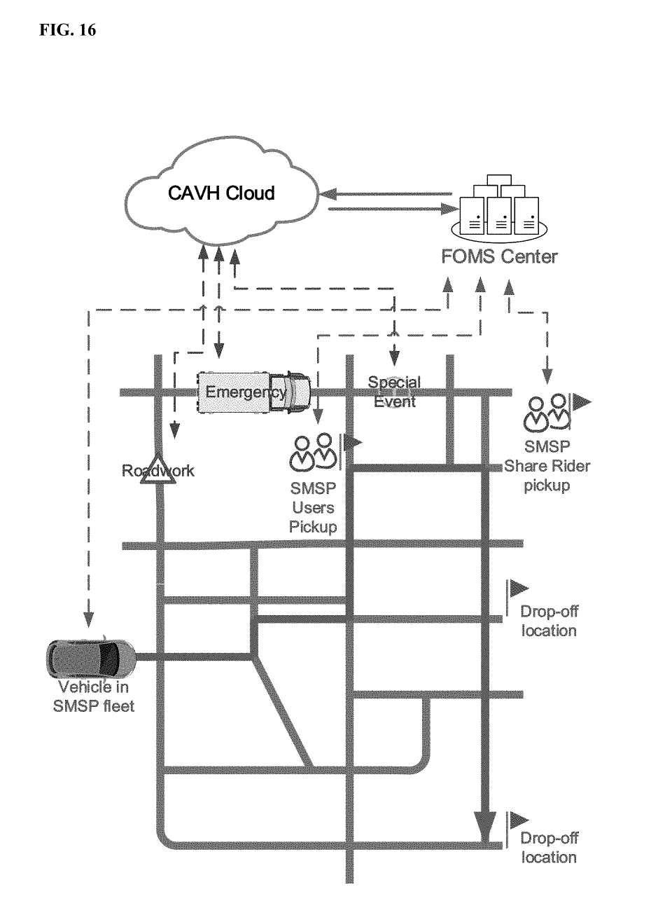

FIG. 16 illustrates an example of how a FOMS system works with assistance from CAVH. Firstly, the SMSP users and share riders request service at their ends with the demand of schedule, pickup/drop-off locations data, which are sent directly to the FOMS center. Then, the center finds the suitable vehicle in its fleet under management for users. With traffic information (including the road work, congestion, emergency, event, etc.) provided by the CAVH cloud, the center makes an appropriate route for the vehicle to pick up the users and send them to drop-off locations. The route plan made by FOMS center is then send to the CAVH system, which allows the CAVH system to provide automation control service for the fleet vehicles.

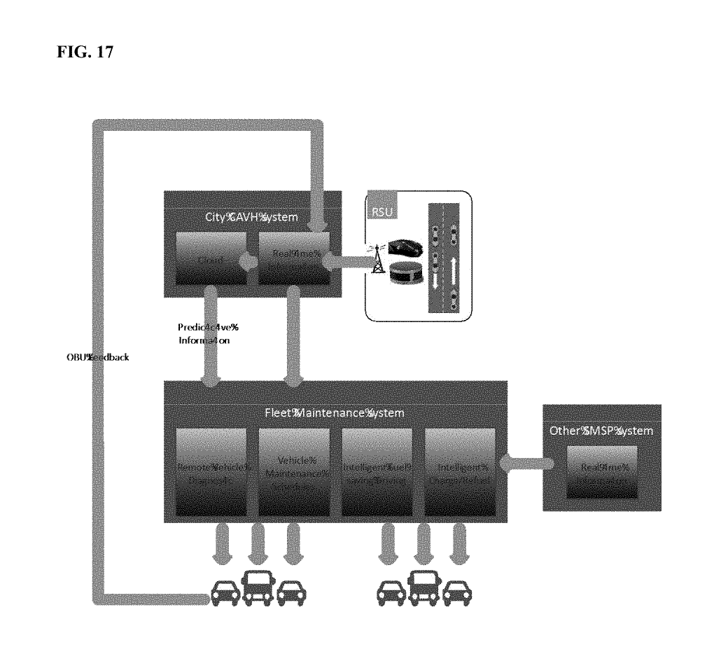

FIG. 17 shows an exemplary architecture of a SMSP fleet maintenance system. The architecture uses real-time information collected from RSU and OBU, predictive information provided by a cloud system and information provided by other SMSP systems through interfaces. The system mainly includes four functions: remote vehicle diagnostic, vehicle maintenance schedules, intelligent fuel-saving driving, and intelligent charge/refuel.

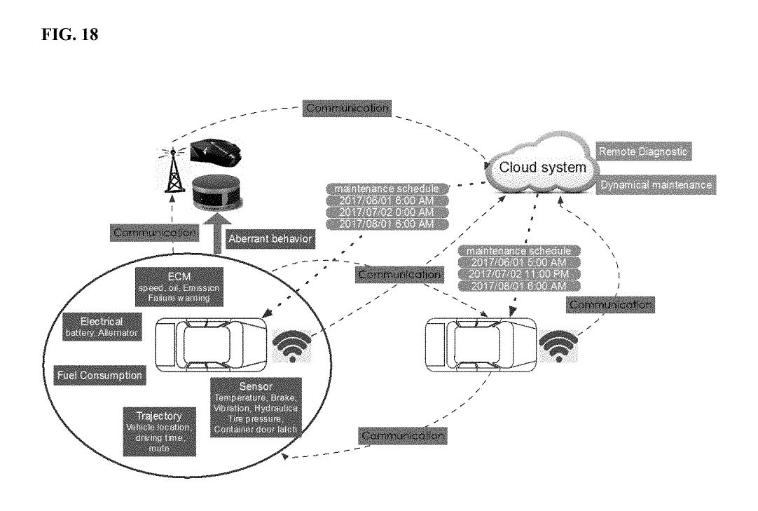

FIG. 18 shows a Remote Vehicle Diagnostics and dynamic maintenance system. This system mainly uses the information collected from an OBU: it includes data from an Engine control module (ECM), electrical data, fuel consumption, trajectory information, and sensor module information. The RSU can monitor the driving behavior of vehicles. The information is sent to RSUs in real-time, other vehicles and the cloud system. The cloud system can then use multi-source information to diagnose the vehicle and determine the maintenance schedules.

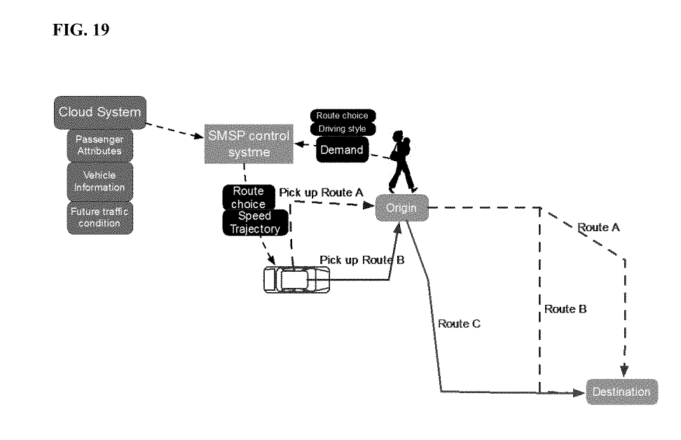

FIG. 19 shows an exemplary intelligent fuel-saving driving system. The system first optimizes the fuel-consumption in a pick-up phase, matching the right passengers to the vehicles by considering the destination, locations of vehicles/passengers, and demands of passengers. Then the system optimizes the fuel-consumption during the driving process. It predicts the future traffic state based on high-resolution traffic state provided by RSUs of the CAVH system and OBUs, and chooses the most economic/time-saving route for the vehicle.

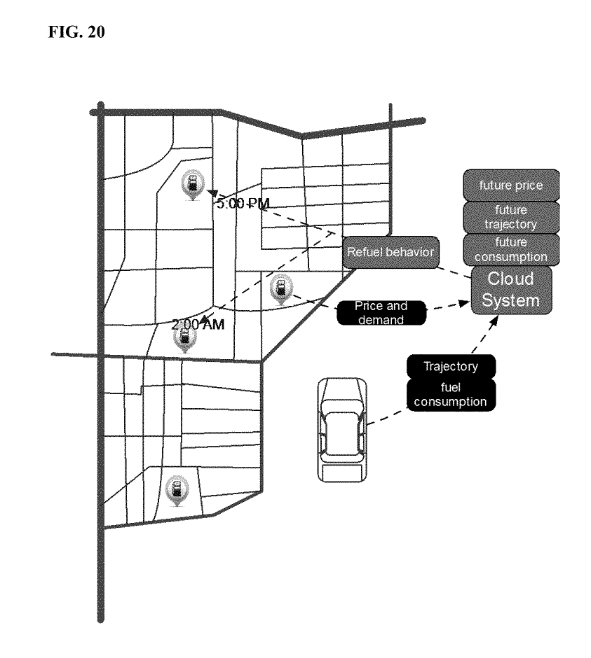

FIG. 20 shows an exemplary intelligent charge/refuel system. This system collects trajectory and fuel consumption information provided by an OBU, and predicts future consumption, trajectory, and energy prices. Then the system determines the charge/refuel behavior of the vehicles based on predictive information.

1-70. (canceled)

71. A shared mobility service provider (SMSP) transportation management system comprising:
i) traffic control centers/traffic control units (TCCs/TCUs) configured to process information and traffic operations instructions; and/or
ii) a network of road side units (RSUs) configured to receive data from connected vehicles, detect traffic conditions, and/or send control instructions to vehicles,
wherein said SMSP transportation management system is configured to:
a) provide vehicles with detailed customized information and/or time-sensitive control instructions for driving tasks; and
b) provide operations and maintenance services for vehicles owned and/or operated by an SMSP.

72. The SMSP transportation management system of claim 71, wherein said driving tasks comprise one or more of car following, lane changing, and/or route guidance.

73. The SMSP transportation management system of claim 71 comprising a point or segment traffic control unit (TCU) combined or integrated into an RSU.

74. The SMSP transportation management system of claim 71 comprising a component to coordinate and/or control automated vehicles, automated vehicles managed by said SMSP, and/or non-automated vehicles.

75. The SMSP transportation management system of claim 71 comprising a SMSP fleet operations and management system (FOMS) configured to provide instructions for vehicles serving users and to provide fleet maintenance activities.

76. The SMSP transportation management system of claim 71 configured to provide control and/or information services to vehicles fully owned by said SMSP, vehicles partially owned or part-timely owned by said SMSP, and/or vehicles owned by another party.

77. The SMSP transportation management system of claim 71 wherein the ownership of a vehicle is and/or may change among privately owned, spatially shared, and/or temporally shared.

78. The SMSP transportation management system of claim 71 configured to identify major roads and minor roads.

79. The SMSP transportation management system of claim 71 comprising a road network management component configured to:
a) provide full operations and control for vehicles on major roads by sending detailed and time-sensitive control instructions to vehicles;
b) provide information to vehicles on minor roads, wherein said vehicles on minor roads are operated and controlled by the on-board systems or the drivers and the SMSP system; and/or
c) control vehicles at a work zone, an accident-prone area, and/or a complex interchange.

80. The SMSP transportation management system of claim 71 comprising a lane management component configured to:
a) control vehicle spacing and/or speed to maximize traffic capacity;
b) predict and/or detect accidents and send warning messages and/or accident avoidance instructions to vehicles;
c) control lane separation and spacing and lane changing; and/or
d) check vehicle permissions of vehicles requesting entrance to a dedicated lane and/or give driving instructions to vehicle requesting exit from a dedicated lane.

81. The SMSP transportation management system of claim 71 comprising one or more interface components configured to interact and/or cooperate with a government CAVH system and/or other shared mobility systems.

82. The SMSP transportation management system of claim 81 wherein said interface components comprise an information sharing interface and/or a vehicle control interface.

83. The SMSP transportation management system of claim 71 comprising a dynamic pricing component.

84. The SMSP transportation management system of claim 71 comprising a user priority management component.

85. The SMSP transportation management system of claim 75 wherein said FOMS is configured to:
a) provide scheduling and dispatching strategies for SMSP vehicles;
b) provide route guidance for SMSP vehicles; and
c) provide traffic information to SMSP vehicles.

86. The SMSP transportation management system of claim 71 comprising a fleet route guidance component.

87. The SMSP transportation management system of claim 71 comprising a remote vehicle diagnostic component.

88. The SMSP transportation management system of claim 71 comprising a vehicle maintenance component.

89. The SMSP transportation management system of claim 71 comprising an intelligent fuel-saving driving component.

90. The SMSP transportation management system of claim 71 comprising an intelligent charge/refuel component.

91. The SMSP transportation management system of claim 71 comprising a plurality of road types.

92. The SMSP transportation management system of claim 91 comprising a geo-fencing technology that separates a first road type and a second road type of the plurality of road types.

93. The SMSP transportation management system of claim 91 wherein said plurality of road types comprises dedicated lanes, non-dedicated lanes, and combinations of dedicated and non-dedicated lanes.

94. The SMSP transportation management system of claim 91 wherein said plurality of road types comprises major roads and minor roads.

95. The SMSP transportation management system of claim 94 wherein said SMSP defines major roads and/or minor roads based on one or more of the following criteria:
a) one or more fixed criteria selected from position of the road in a transportation hierarchy of roads, design traffic capacity, design speed, number of lanes, and/or land width;
b) one or more statistical criteria selected from traffic volume, average speed, travel time, and/or volume of SMSP vehicles;
c) one or more infrastructure criteria selected from RSU layout density, RSU coverage area, high resolution map level; and/or
d) one or more incident criteria selected from traffic accident, special event, and/or road closure.

96. The SMSP transportation management system of claim 95 wherein the definitions of major roads and minor roads are static or variable over fixed or dynamic time periods and may be temporarily changed.

97. The SMSP transportation management system of claim 94 wherein the SMSP defines a road having high RSU coverage, high resolution map coverage, high demand, and/or high traffic volume as a major road.

98. The SMSP transportation management system of claim 93 wherein a dedicated lane is defined as a lane for use by vehicles based on vehicle automation and/or communication capabilities.

99. The SMSP transportation management system of claim 93 wherein a dedicated lane collects traffic information and communicates traffic information and control instructions to vehicles.

100. The SMSP transportation management system of claim 93 wherein a dedicated lane is either physical or logical.

101. The SMSP transportation management system of claim 100 wherein a physical dedicated lane is physically separated from non-dedicated lanes and has a fixed entrance and exit.

102. The SMSP transportation management system of claim 100 wherein logical dedicated lanes are not physically separated from non-dedicated lanes and vehicles require permissions from corridor TCCs/TCUs or SMSP TCCs to enter and/or leave the dedicated lanes.

103. The system of claim 93 wherein a non-dedicated lane is defined as a lane use for use by vehicles based on vehicle communication capabilities.

104. The SMSP transportation management system of claim 93 wherein a non-dedicated lane collects lane traffic information through sensing systems and communicates lane traffic information to vehicles using the lane.

105. The SMSP transportation management system of claim 93 wherein a non-dedicated lane requests control of a vehicle using the non-dedicated lane.

106. A method for managing connected automated vehicles with a shared mobility service provider (SMSP) transportation management system, the method comprising:
a) providing traffic control centers/traffic control units (TCCs/TCUs) configured to process information and traffic operations instructions; and/or a network of road side units (RSUs) configured to receive data from connected vehicles, detect traffic conditions, and/or send control instructions to vehicles;
b) providing vehicles with detailed customized information and/or time-sensitive control instructions for driving tasks; and
c) providing operations and maintenance services for vehicles owned and/or operated by an SMSP.
